(19) United States
(12) Patent Application Publication
(10) Pub. No.: US 2014/0137227 A1
(43) Pub. Date: May 15, 2014

(54) Systems and Methods for Enhancement of Single Sign-On Protection

(71) Applicant: Tencent Technology (Shenzhen) Company Limited, Shenzhen (CN)

(72) Inventors: Hai Long, Shenzhen (CN); Yinming Mei, Shenzhen (CN)

(73) Assignee: Tencent Technology (Shenzhen) Company Limited, Shenzhen (CN)

(21) Appl. No.: 14/161,791

(22) Filed: Jan. 23, 2014

Related U.S. Application Data
(63) Continuation of application No. PCT/CN2013/082525, filed on Aug. 29, 2013.

(30) Foreign Application Priority Data
Sep. 3, 2012 (CN) 201210321782.X

(51) Int. Cl. H04L 29/06

(52) U.S. Cl. CPC H04L 63/0815
USPC 726/8

(57) ABSTRACT

Systems and methods are provided for enhancement of single sign-on protection. For example, information associated with one or more executable files related to an application process is acquired at a beginning of the application process; whether the one or more executable files are included in a pre-established white-list database is determined based on at least information associated with the executable files; a target uniform-resource locator (URL) associated with the application process is acquired in response to the one or more executable files being not included in the pre-established white-list database; and in response to the target URL being included in a pre-established log-in URL database on an authentication server, the application process is intercepted, and/or a risk notification is provided to a user.

### 1. CROSS-REFERENCES TO RELATED APPLICATIONS

This application claims priority to Chinese Patent Application No. 201210321782.X, filed Sep. 3, 2012, incorporated by reference herein for all purposes.

### 2. BACKGROUND OF THE INVENTION

The present invention is directed to computer technology. More particularly, the invention provides systems and methods for computer security. Merely by way of example, the invention has been applied to network communication. But it would be recognized that the invention has a much broader range of applicability.

In a single sign-on technique, when a user accesses an application system for a first time, the user may be guided to an authentication system to log in. The authentication system may verify the identity of the logged-in user based on the login information provided by the user. If the user passes the verification, an authentication credential, e.g., a ticket, may be provided to the user. When the user accesses other application systems, the ticket serves as the user's authentication credential. These application systems which receive an access request from the user may send the user's ticket to the authentication system to verify the validity of the ticket, if the ticket is verified, the user can gain access to these application systems without being prompted to log in again.

A single sign-on account system involves users logging in at a client. For example, an instant messaging client (e.g., QQ) may allow a simple and quick log-in. When a user accesses a certain webpage, the webpage script may detect information related to an account which is logged in at the client and use the currently logged-in account to realize one-click log-in without further password authentication. After the log-in, the user obtains a partial authority or a complete authority related to the currently logged-in account at the client.

With the rapid development of the Internet, personal information, network accounts and virtual property on the Internet have become a user's private assets which can be converted into economic benefits. But the safety of users' online virtual assets is often negatively affected by illegal attempts to steal or misuse the users' “private assets” for economic gains.

A single sign-on system may be subject to malicious attacks because of the unique features of the single sign-on technique. Malicious programs may process information related to the single sign-on protocol and simulate a user's log-in through a webpage, so that a server may mistakenly determine that the user has logged in normally. The user's information may be misappropriated; the user's virtual assets may be stolen; or some malicious promotion may be carried out to cause losses to the user.

Hence it is highly desirable to improve the techniques for enhancing protection of single sign-on systems.

### 3. BRIEF SUMMARY OF THE INVENTION

The present invention is directed to computer technology. More particularly, the invention provides systems and methods for computer security. Merely by way of example, the invention has been applied to network communication. But it would be recognized that the invention has a much broader range of applicability.

According to one embodiment, a method is provided for enhancement of single sign-on protection. For example, information associated with one or more executable files related to an application process is acquired at a beginning of the application process; whether the one or more executable files are included in a pre-established white-list database is determined based on at least information associated with the executable files; a target uniform-resource locator (URL) associated with the application process is acquired in response to the one or more executable files being not included in the pre-established white-list database; and in response to the target URL being included in a pre-established log-in URL database on an authentication server, the application process is intercepted, and/or a risk notification is provided to a user.

According to another embodiment, a device for enhancement of single sign-on protection includes a file-information-acquisition module, a determination module, a target-URL-acquisition module, and a processing module. The file-information-acquisition module is configured to acquire information associated with one or more executable files related to an application process at a beginning of the application process. The determination module is configured to determine whether the one or more executable files are included in a pre-established white-list database based on at least information associated with the executable files. The target-URL-acquisition module is configured to acquire a target URL associated with the application process in response to the one or more executable files being not included in the pre-established white-list database. The processing module is configured to, in response to the target URL being included in a pre-established log-in URL database on an authentication server, intercept the application process or provide a risk notification to a user.

In one embodiment, a non-transitory computer readable storage medium includes programming instructions for enhancement of single sign-on protection. The programming instructions are configured to cause one or more data processors to execute certain operations. For example, information associated with one or more executable files related to an application process is acquired at a beginning of the application process; whether the one or more executable files are included in a pre-established white-list database is determined based on at least information associated with the executable files; a target uniform-resource locator (URI) associated with the application process is acquired in response to the one or more executable files being not included in the pre-established white-list database; and in response to the target URL being included in a pre-established log-in URL database on an authentication server, the application process is intercepted, and/or a risk notification is provided to a user.

In another embodiment, a computer-implemented system for enhancement of single sign-on protection includes one or more data processors and a computer-readable storage medium, The storage medium is encoded with instructions for commanding the data processors to execute certain operations. For example, information associated with one or more executable files related to an application process is acquired at a beginning of the application process; whether the one or more executable files are included in a pre-established white-list database is determined based on at least information associated with the executable files; a target uniform-resource locator (URL) associated with the application process is acquired in response to the one or more executable files being not included in the pre-established white-list database; and in response to the target URL being included in a pre-established log-in URL database on an authentication server, the application process is intercepted, and/or a risk notification is provided to a user.

For example, the systems and methods described herein may be implemented to establish a white-list database and a URL database on an authentication server and, when a program not included in the white-list database accesses a URL included in the URL log-in database on the authentication server, to intercept the application process related to the program and/or provide a risk notification to a user. In another example, the systems and methods described herein may be configured to effectively intercept malicious simulation of single sign-on, protect users' personal information and virtual properties and monitor certain behaviors of new types of Trojans so as to improve system security.

Depending upon embodiment, one or more benefits may be achieved. These benefits and various additional objects, features and advantages of the present invention can be fully appreciated with reference to the detailed description and accompanying drawings that follow.

### 4. BRIEF DESCRIPTION OF THE DRAWINGS

FIG. 1 is a simplified diagram showing a method for enhancement of single sign-on protection according to one embodiment of the present invention;

FIG. 2 is a simplified diagram showing a process for acquiring a target URL associated with the application process as part of the method as shown in FIG. 1 according to one embodiment of the present invention;

FIG. 3 is a simplified diagram showing a method for enhancement of single sign-on protection according to another embodiment of the present invention;

FIG. 4 is a simplified diagram of a device for enhancement of single sign-on protection according to one embodiment of the present invention;

FIG. 5 is a simplified diagram of a target-URL-acquisition module as part of the device as shown in FIG. 4 according to one embodiment of the present invention; and

FIG. 6 is a simplified diagram of a device for enhancement of single sign-on protection according to another embodiment of the present invention.

### 5. DETAILED DESCRIPTION OF THE INVENTION

The present invention is directed to computer technology. More particularly, the invention provides systems and methods for computer security. Merely by way of example, the invention has been applied to network communication, But it would be recognized that the invention has a much broader range of applicability.

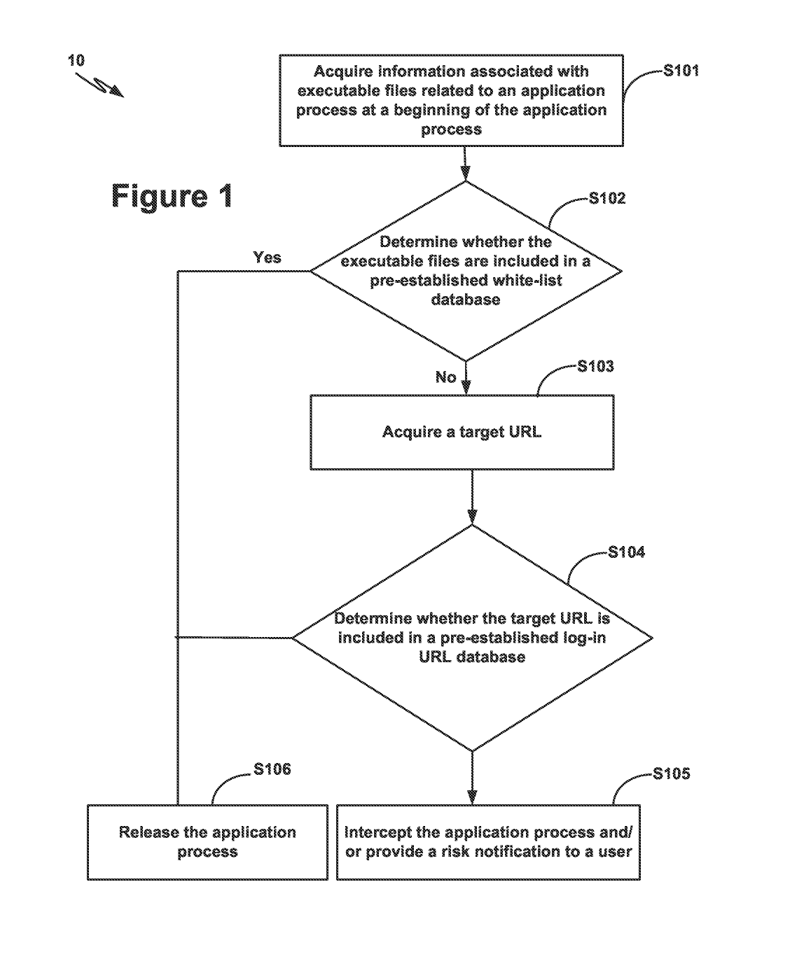

FIG. 1 is a simplified diagram showing a method for enhancement of single sign-on protection according to one embodiment of the present invention. This diagram is merely an example, which should not unduly limit the scope of the claims. One of ordinary skill in the art would recognize many variations, alternatives, and modifications. The method 10 includes at least the process S101 for acquiring information associated with executable files related to an application process at a beginning of the application process, the process S102 for determining whether the executable files are included in a pre-established white-list database, the process S103 for acquiring a target uniform resource locator (URL) associated with the application process, the process S104 for determining whether the target URL is included in a pre-established log-in URL database on an authentication server, the process S105 for intercepting the application process and/or providing a risk notification to a user, and the process S106 for releasing the application process.

According to one embodiment, the process S101 includes acquiring information associated with one or more executable files related to an application process at a beginning of the application process. For example, the information associated with the one or more executable files related to the application process is obtained through injection into the started application process related to any single sign-on account. As an example, the information associated with the one or more executable files includes the names of the executable files related to the application process.

According to another embodiment, the process S102 includes determining whether the one or more executable files are included in a pre-established white-list database based on at least information associated with the executable files: if yes, the process S106 is executed; and if not, the process S103 is executed. For example, the process S103 includes acquiring a target URL associated with the application process in response to the one or more executable files being not included in the pre-established white-list database, and then the process S104 is executed. As an example, the process S104 includes determining whether the target URL is included in a pre-established log-in URL database on an authentication server; if yes, the process S105 is executed; and if not, the process S106 is executed. The process S105 includes intercepting the application process and/or providing a risk notification to the user, according to some embodiments. For example, the process S106 includes releasing the application process.

As described in the processes S102-S106, after the information associated with the executable files related to the application process is acquired, the pre-established white-list database is searched to determine whether the executable files are included in the pre-established white-list database, in some embodiments. For example, if the executable files are included in the pre-established white-list database, the application process is released. Otherwise, a filter layer is added to the application process, and a hyper-text-transfer-protocol (HTTP) access request of the application process is intercepted using the filter layer, according to certain embodiments. For example, information associated with the HTTP access request is processed, and one or more URLs are extracted based on at least information associated with the HTTP access request. As an example, the target URL is acquired based on at least information associated with the one or more first URLs. in one embodiment, the pre-established log-in URL database on the authentication server is searched to determine whether the target URL is included in the log-in URL database. For example, the log-in URL database on the authentication server includes known automatic log-in URLs of well-known accounts, such as the automatic log-in URLs of Tencent. In another example, the log-in URL database includes log-in URLs of certain verified accounts.

According to another embodiment, if the target URL is included in the log-in URL database on the authentication server and related to URL requests for single sign-on of certain accounts, a risk notification is provided to the user, and/or the application process is intercepted. For example, if the target URL is not included in the log-in URL database, the application process is released.

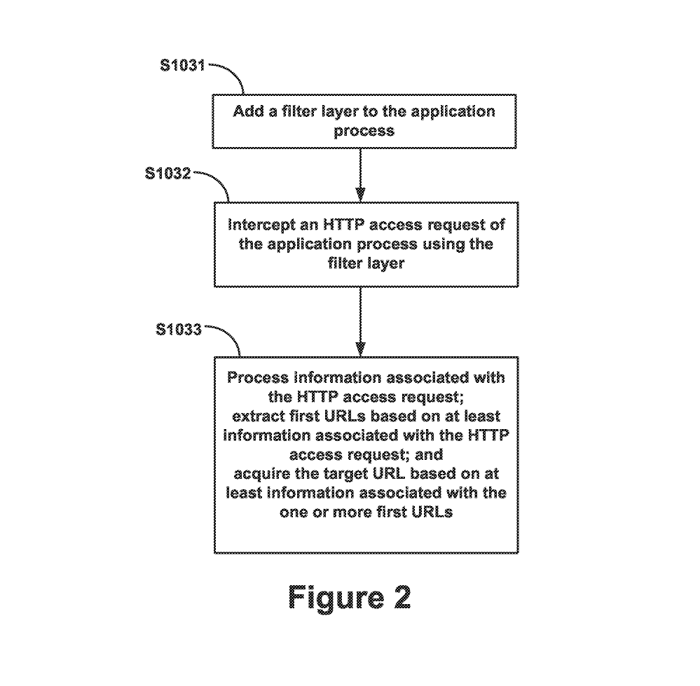

FIG. 2 is a simplified diagram showing the process S103 for acquiring a target URL associated with the application process as part of the method 10 according to one embodiment of the present invention. This diagram is merely an example, which should not unduly limit the scope of the claims. One of ordinary skill in the art would recognize many variations, alternatives, and modifications. The process S103 includes at least the sub-process S1031 for adding a filter layer to the application process, the sub-process S1032 for intercepting a HTTP access request of the application process using the filter layer, and the sub-process S1033 for processing information associated with the HTTP access request, extracting one or more first URLs based on at least information associated with the HTTP access request, and acquiring the target URL based on at least information associated with the one or more first URLs.

According to one embodiment, the sub-process S1031 includes adding a filter layer to the application process. For example, the filter layer includes a user-mode socket function hook, or a network filter driver associated with a system kernel configured to filter network access operations in the application process. As an example, the sub-process S1032 includes intercepting a HTTP access request of the application process using the filter layer. In another example, the sub-process S1033 includes processing information associated with the HTTP access request, extracting one or more first URLs based on at least information associated with the HTTP access request, and acquiring the target URL based on at least information associated with the one or more first URLs.

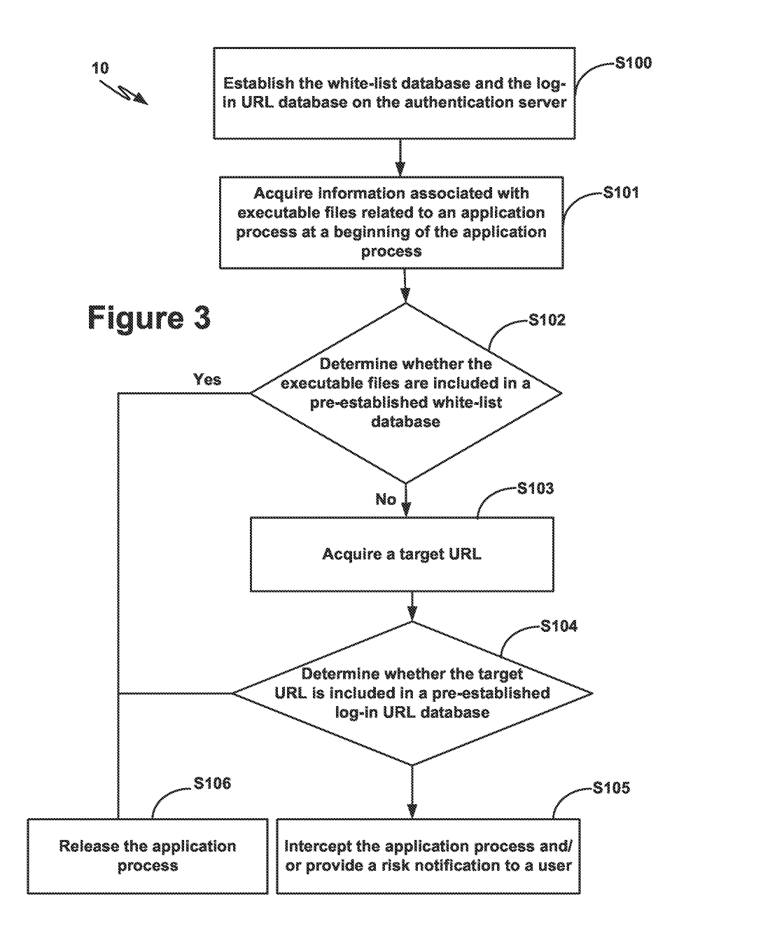

FIG. 3 is a simplified diagram showing the method 10 for enhancement of single sign-on protection according to another embodiment of the present invention. This diagram is merely an example, which should not unduly limit the scope of the claims. One of ordinary skill in the art would recognize many variations, alternatives, and modifications. In addition to the processes shown in FIG. 1, the method 10 further includes the process S100 for establishing the white-list database and the log-in URL database on the authentication server. For example, the process S100 is executed before the process S101.

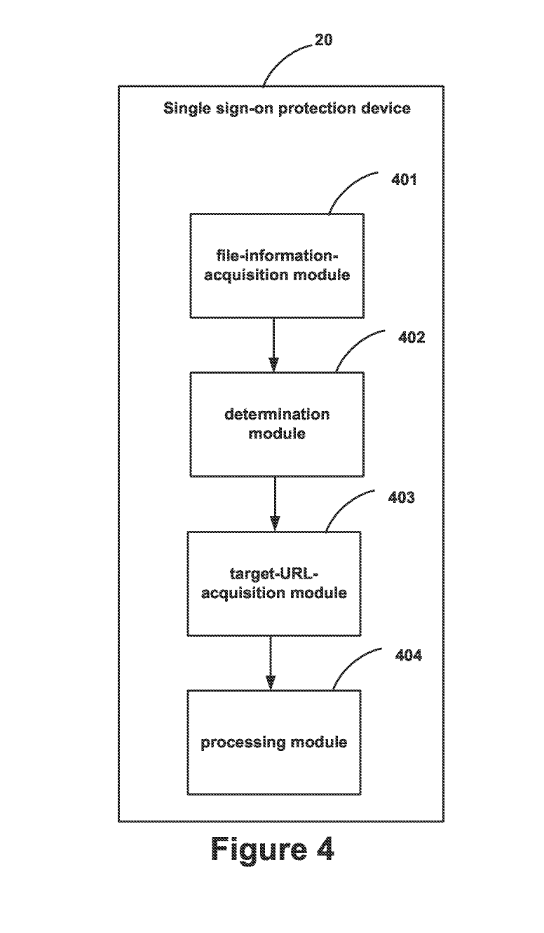

FIG. 4 is a simplified diagram of a device for enhancement of single sign-on protection according to one embodiment of the present invention. This diagram is merely an example, which should not unduly limit the scope of the claims. One of ordinary skill in the art would recognize many variations, alternatives, and modifications. The device 20 includes a file-information-acquisition module 401, a determination module 402, a target-URL-acquisition module 403, and a processing module 404.

According to one embodiment, the file-information-acquisition module 401 is configured to acquire information associated with one or more executable files related to an application process at a beginning of the application process. For example, the determination module 402 is configured to determine whether the one or more executable files are included in a pre-established white-list database based on at least information associated with the executable files. As an example, the target-URL-acquisition module 403 is configured to acquire a target URL associated with the application process in response to the one or more executable files being not included in the pre-established white-list database.

According to another embodiment, the processing module 404 is configured to, in response to the target URL being included in a pre-established log-in URL database on an authentication server, intercept the application process and/or provide a risk notification to a user. For example, the processing module 404 is further configured to, in response to the executable files of the application process being included in the pre-established white-list database, release the application process. In another example, the processing module 404 is further configured to, in response to the target URL being not included in the pre-established log-in URL database on the authentication server, release the application process.

According to yet another embodiment, the file-information-acquisition module 401 is further configured to obtain the information associated with the one or more executable files related to the application process through injection into the started application process related to any single sign-on account. As an example, the information associated with the one or more executable files includes the names of the executable files related to the application process.

After the information associated with the executable files related to the application process is acquired, the determination module 402 is further configured to search the pre-established white-list database to determine whether the executable files are included in the pre-established white-list database, in some embodiments. For example, if the executable files are included in the pre-established white-list database, the application process is released. Otherwise, the target-URL-acquisition module 403 is further configured to add a filter layer to the application process, and intercept a hyper-text-transfer-protocol (HTTP) access request of the application process using the filter layer, according to certain embodiments. For example, the target-URL-acquisition module 403 is further configured to process information associated with the HTTP access request, extract one or more URLs based on at least information associated with the HTTP access request, and acquire the target URL based on at least information associated with the one or more first URLs. In one embodiment, the pre-established URL database on the authentication server is searched to determine whether the target URL is included in the log-in URL database. For example, the log-in URL database on the authentication server includes known automatic log-in URLs of well-known accounts, such as the automatic log-in URLs of Tencent. In another example, the log-in URL database includes log-in URLs of certain verified accounts.

In one embodiment, the processing module 404 is further configured to provide a risk notification to the user, and/or intercept the application process, if the target URL is included in the log-in URL database on the authentication server and related to URL requests for single sign-on of certain accounts. For example, if the target URL is not included in the log-in URL database, the processing module 404 is further configured to release the application process.

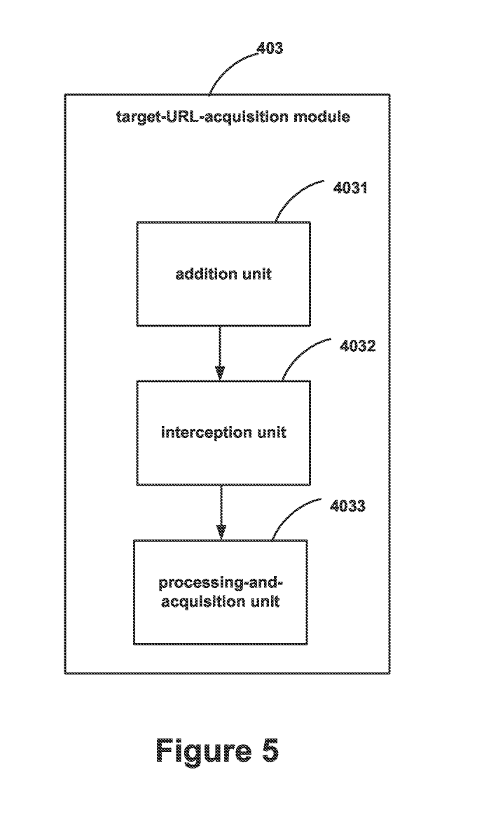

FIG. 5 is a simplified diagram of the target-URL-acquisition module 403 as part of the device 20 according to one embodiment of the present invention. This diagram is merely an example, which should not unduly limit the scope of the claims. One of ordinary skill in the art would recognize many variations, alternatives, and modifications. The target-URL-acquisition module 403 includes an addition unit 4031, an interception unit 4032, and a processing-and-acquisition unit 4033.

According to one embodiment, the addition unit 4031 is configured to add a filter layer to the application process. For example, the interception unit 4032 is configured to intercept an HTTP access request of the application process using the filter layer. As an example, the processing-and-acquisition unit 4033 is configured to process information associated with the HTTP access request, extract one or more first URLs based on at least information associated with the HTTP access request, and acquire the target URL based on at least information associated with the one or more first URLs.

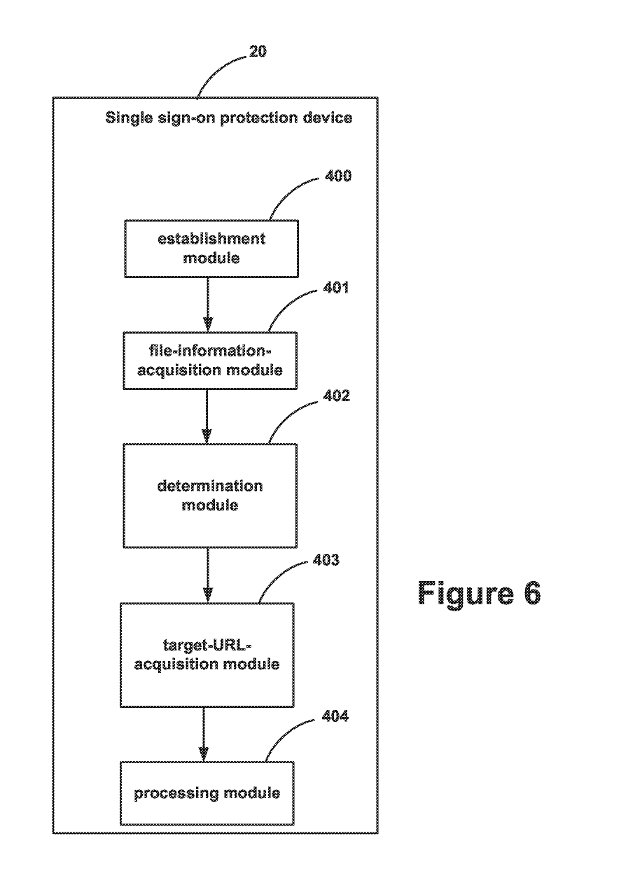

FIG. 6 is a simplified diagram of the device 20 for enhancement of single sign-on protection according to another embodiment of the present invention. This diagram is merely an example, which should not unduly limit the scope of the claims. One of ordinary skill in the art would recognize many variations, alternatives, and modifications. In addition to the modules shown in FIG. 4, the device 20 further includes an establishment module 400 configured to establishing the white-list database and the log-in URL database on the authentication server.

According to one embodiment, a method is provided for enhancement of single sign-on protection. For example, information associated with one or more executable files related to an application process is acquired at a beginning of the application process; whether the one or more executable files are included in a pre-established white-list database is determined based on at least information associated with the executable files; a target uniform-resource locator (URL) associated with the application process is acquired in response to the one or more executable files being not included in the pre-established white-list database; and in response to the target URL being included in a pre-established log-in URL database on an authentication server, the application process is intercepted, and/or a risk notification is provided to a user. For example, the method is implemented according to FIG. 1, FIG. 2, FIG. 3, FIG. 4, FIG. 5, and/or FIG. 6.

According to another embodiment, a device for enhancement of single sign-on protection includes a file-information-acquisition module, a determination module, a target-URL-acquisition module, and a processing module. The file-information-acquisition module is configured to acquire information associated with one or more executable files related to an application process at a beginning of the application process. The determination module is configured to determine whether the one or more executable files are included in a pre-established white-list database based on at least information associated with the executable files. The target-URL-acquisition module is configured to acquire a target URL associated with the application process in response to the one or more executable files being not included in the pre-established white-list database. The processing module is configured to, in response to the target URL being included in a pre-established log-in URL database on an authentication server, intercept the application process or provide a risk notification to a user. For example, the device is implemented according to FIG. 1, FIG. 2, FIG. 3, FIG. 4, FIG. 5, and/or FIG. 6.

In one embodiment, a non-transitory computer readable storage medium includes programming instructions for enhancement of single sign-on protection. The programming instructions are configured to cause one or more data processors to execute certain operations. For example, information associated with one or more executable files related to an application process is acquired at a beginning of the application process; whether the one or more executable files are included in a pre-established white-list database is determined based on at least information associated with the executable files; a target uniform-resource locator (URL) associated with the application process is acquired in response to the one or more executable files being not included in the pre-established white-list database; and in response to the target URL being included in a pre-established log-in URL database on an authentication server, the application process is intercepted, and/or a risk notification is provided to a user. For example, the storage medium is implemented according to FIG. 1, FIG. 2, FIG. 3, FIG. 4, FIG. 5, and/or FIG. 6.

In another embodiment, a computer-implemented system for enhancement of single sign-on protection includes one or more data processors and a computer-readable storage medium. The storage medium is encoded with instructions for commanding the data processors to execute certain operations. For example, information associated with one or more executable files related to an application process is acquired at a beginning of the application process; whether the one or more executable files are included in a pre-established white-list database is determined based on at least information associated with the executable files; a target uniform-resource locator (URL) associated with the application process is acquired in response to the one or more executable files being not included in the pre-established white-list database; and in response to the target URL being included in a pre-established log-in URL database on an authentication server, the application process is intercepted, and/or a risk notification is provided to a user. For example, the system is implemented according to FIG. 1, FIG. 2, FIG. 3, FIG. 4, FIG. 5, and/or FIG. 6.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits in yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A processor-implemented method for enhancement of single sign-on protection, the method comprising:
acquiring, using one or more data processors, information associated with one or more executable files related to an application process at a beginning of the application process;
determining, using the one or more data processors, whether the one or more executable files are included in a pre-established white-list database based on at least information associated with the executable files;
acquiring, using one or more data processors, a target uniform-resource locator (URL) associated with the application process in response to the one or more executable files being not included in the pre-established white-list database; and
in response to the target URL being included in a pre-established log-in URL database on an authentication server,
intercepting the application process; or
providing a risk notification to a user.

2. The method of claim 1 wherein the acquiring the target URL associated with the application process comprises:
adding a filter layer to the application process;
intercepting a hyper-text-transfer-protocol (HTTP) access request of the application process using the filter layer;
processing information associated with the HTTP access request;
extracting one or more first URLs based on at least information associated with the HTTP access request; and
acquiring the target URL based on at least information associated with the one or more first URLs.

3. The method of claim 2 wherein the filter layer includes a user-mode socket function hook or a network filter driver associated with a system kernel.

4. The method of claim 1, further comprising:
establishing the white-list database and the log-in URL database on the authentication server.

5. The method of claim 1, further comprising:
releasing the application process in response to the executable files related to the application process being included in the pre-established white-list database.

6. The method of claim 1, further comprising:
releasing the application process in response to the target URL being not included in the pre-established log-in URL database on the authentication server.

7. The method of claim 1, further comprising:
in response to the target URL being included in a pre-established log-in URL database on an authentication server, intercepting the application process and providing a risk notification to a user.

8. A device for enhancement of single sign-on protection, the device comprising:
a file-information-acquisition module configured to acquire information associated with one or more executable files related to an application process at a beginning of the application process;
a determination module configured to determine whether the one or more executable files are included in a pre-established white-list database based on at least information associated with the executable files;
target-URL-acquisition module configured to acquire a target URL associated with the application process in response to the one or more executable files being not included in the pre-established white-list database; and
a processing module configured to, in response to the target URL being included in a pre-established log-in URL database on an authentication server, intercept the application process or provide a risk notification to a user.

9. The device of claim 8, wherein the target URL-acquisition module includes:
an addition unit configured to add a filter layer to the application process;
an interception unit configured to intercept an HTTP access request of the application process using the filter layer; and
an processing-and-acquisition unit configured to process information associated with the HTTP access request, extract one or more first URLs based on at least information associated with the HTTP access request, and acquire the target URL based on at least information associated with the one or more first URLs.

10. The device of claim 8 wherein the filter layer includes a user-mode socket function hook or a network filter driver associated with a system kernel.

11. The device of claim 8, further comprising:
an establishment module configured to establishing the white-list database and the log-in URL database on the authentication server.

12. The device of claim 8 wherein the processing module is further configured to:
in response to the executable files of the application process being included in the pre-established white-list database, release the application process; and
in response to the target URL being not included in the pre-established log-in URL database on the authentication server, release the application process.

13. The device of claim 8 wherein the processing module is further configured to, in response to the target URL being included in a pre-established log-in URL database on an authentication server, intercept the application process and provide a risk notification to a user.

14. A non-transitory computer readable storage medium comprising programming instructions for enhancement of single sign-on protection, the programming instructions configured to cause one or more data processors to execute operations comprising:
acquiring information associated with one or more executable files related to an application process at a beginning of the application process;
determining whether the one or more executable files are included in a pre-established white-list database based on at least information associated with the executable files;
acquiring a target uniform resource locator (URL) associated with the application process in response to the one or more executable files being not included in the pre-established white-list database; and
in response to the target URL being included in a pre-established log-in URL database on an authentication server,
intercepting the application process; or
providing a risk notification to a user.

15. A computer-implemented system for enhancement of single sign-on protection, said system comprising:
one or more data processors; and
a computer-readable storage medium encoded with instructions for commanding the data processors to execute operations including:
acquiring information associated with one or more executable files related to an application process at a beginning of the application process;
determining whether the one or more executable files are included in a pre-established white-list database based on at least information associated with the executable files;
acquiring a target uniform resource locator (URL) associated with the application process in response to the one or more executable files being not included in the pre-established white-list database; and
in response to the target URL being included in a pre-established log-in database on an authentication server,
intercepting the application process; or
providing a risk notification to a user.
